(19) United States
(12) Patent Application Publication
(10) Pub. No.: US 2006/0063009 A1
(43) Pub. Date: Mar. 23, 2006

(54) Glass member

(76) Inventors: Takashi Naitou, Mito (JP); Motoyuki Miyata, Hitachinaka (JP); Hiroyuki Akata, Hitachi (JP); Yuichi Sawai, Hitachi (JP); Osamu Shiono, Hitachi (JP); Tatsumi Hirano, Hitachinaka (JP); Hiroki Yamamoto, Hitachi (JP); Hideto Momose, Hitachiota (JP); Takao Miwa, Hitachinaka (JP); Yuzo Kozono, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/205,176

(22) Filed: Aug. 17, 2005

(30) Foreign Application Priority Data
Sep. 17, 2004 (JP) 2004-272255

(51) Int. Cl. C03C 3/095; B32B 17/06

(52) U.S. Cl. 428/427; 501/64

(57) ABSTRACT

The present invention is envisioned to provide a high-strength glass which is applicable to the objective of size and weight reduction. A compression stress layer is formed in a surface portion of an oxide-based glass containing at least one rare earth element selected from the group consisting of Pr, Nd, Sm, Eu, Gd, Tb, Dy, Ho, Er, Tm, Yb and Lu and further containing at least Si element and an alkali metal element.

### FIELD OF THE INVENTION

The present invention relates to a high-strength glass which is drastically improved in shatter resistance and finds useful application to various kinds of structural members, glass products and other products utilizing glass which are required to maintain shatter resistance even if reduced in size and weight.

### BACKGROUND OF THE INVENTION

Glass is utilized for a very wide variety of articles ranging from tableware, window glass and its sort which are found close to us, to electronic devices such as displays and storages and transportation means such as various kinds of vehicles and aircraft. It has been the general concept that glass is fragile and easily broken, and realization of unbreakable glass has been but a fantacy. As means for strengthening glass, there have been known several methods such as chemical strengthening, air blast cooling and crystallization. Nevertheless, even with the glass which has had such treatments, or so-called strengthened glass, the improvement of strength is limited to approximately double to thrice the strength of the non-treated glass (ordinary glass). In this field of industry, development of high-strength glass having four or more times higher strength than ordinary glass is being pushed ahead for application to flat panel displays (FPD).

It is considered that a shatter (break) of glass occurs as the innumerable microcracks existing in the glass surface are forced to grow up to the greater cracks when a bending stress is exerted thereto. It is impossible to eliminate such microcracks from the glass surface. Therefore, it has been tried to obtain so-called strengthened glass by subjecting ordinary glass to the various strengthening treatments such as mentioned above.

As an example of glass strengthening treatments, Patent Document 1 and Patent Document 2 disclose a chemical treatment in which a rare earth oxide (such as La₂O₃, Y₂O₃ or CeO₂) is incorporated in ordinary glass in an amount of 1% by weight or less. Also, Patent Document 3 discloses a method in which ultra-shortwave laser is applied to ordinary glass to form a heterogeneous phase in the surface portion of this glass to thereby inhibit growth of the cracks.

Air blast cooling is a treatment in which cold air is blown against the heated glass surface to form a compression strengthened layer on this glass surface to thereby prevent formation of cracks. This treatment is principally targeted at the large-sized plate glass, 4 mm or greater in thickness, which is mostly used for vehicles or building materials. The crystallization method features forming the crystal grains with a size of 100 nm or greater in the inside of amorphous glass to suppress the growth of the microcracks to the larger cracks in the glass surface by the presence of the crystal grains, thereby to strengthen the whole body of glass.

Patent Document 1: JP-A-2001-302278

Patent Document 2: JP-A-5-32431

Patent Document 3: JP-A-2003-286048

### BRIEF SUMMARY OF THE INVENTION

In the chemical strengthening method which is a conventional concept of means for strengthening glass, the glass surface is subjected to alkaline ion exchange for replacing Li ions in the surface portion of ordinary glass with Na ions, and the Na ions in the surface portion of ordinary glass with K ions, to form a compression strengthened layer on the glass surface. “Unbreakable glass” is required to have strength which is about ten times that of ordinary glass as a result of the strengthening treatments. The strength enhancing effect by the conventional chemical treatments, however, is limited to about double or thrice higher strength than ordinary glass and far from being capable of providing “unbreakable glass”. Further, such strengthened glass involves the problem of low heat resistance (drop of strength on heating). Also, strength of the “strengthened glass” obtained by the conventional crystallization treatment is only about double that of ordinary glass, and such “strengthened glass” is low in transparency. As viewed above, it has been hardly possible to realize unbreakable glass with the prior art technology.

An object of the present invention is to provide a high-strength glass which is applicable to the scheme for size and weight reduction. The high-strength glass according to the present invention is capable of realizing enhancement of strength by about ten times over the ordinary glass and finds its useful application to a wide variety of articles such as mentioned above including substrates for FPD, various kinds of glass-utilizing products, building materials, etc.

In order to attain the above object, the present invention provides a glass member comprising:

an oxide-based glass containing at least one rare earth element selected from the group consisting of Pr, Nd, Sm, Eu, Gd, Tb, Dy, Ho, Er, Tm, Yb and Lu and also containing at least an Si element and an alkali metal element; and

a compression stress layer formed in a surface portion of the oxide-based glass. The “surface portion” of the oxide-based glass referred to in this invention signifies a part in a very shallow region from the outermost surface of the glass in a depth direction, which will be further explained in the section of Examples.

In the present invention, it is possible to contain in the base glass an oxide (Ln₂O₃) of Pr, Nd, Sm, Eu, Gd, Tb, Dy, Ho, Er, Tm, Yb or Lu, preferably an oxide of at least one element selected from the group consisting of Eu, Gd, Dy, Tm, Yb and Lu, more preferably an oxide of Gd.

In the present invention, it is also possible to contain at least one element selected from the group consisting of Ai elements, B elements and an alkali earth metal element in said oxide-based glass.

In the present invention, a rare earth element can be contained in an amount of 1 to 10% by weight, preferably 2 to 7% by weight, calculated as an oxide thereof Ln₂O₃ (Ln: rare earth element), based on the whole oxide-based glass.

In the present invention, the compression stress layer of the glass member can be formed by a chemical strengthening treatment comprising an alkali ion exchange. This compression stress layer preferably has a thickness of 20 μm or greater.

In the present invention, the glass member can contain a rare earth element in an amount of 1 to 10% by weight calculates as an oxide thereof Ln₂O₃ (Ln: rare earth element), an Si element in an amount of 50 to 80% by weight calculated as an oxide thereof SiO₂, and an alkali metal element in an amount of 5 to 20% by weight calculated as an oxide thereof R₂O (R: alkali metal element), based on the whole oxide-based glass, with the total amount of said Ln₂O₃, SiO₂ and R₂O being 65% by weight or more.

In the present invention, it is possible to contain an Al element in an amount of 20% by weight or less calculated as an oxide thereof A1₂O₃, a B element in an amount of 20% by weight or less calculated as an oxide thereof B₂O₃, and an alkali earth metal element in an amount of 20% by weight or less calculated as an oxide thereof R′O (R′: alkali earth metal element), based on the whole oxide-based glass, with the total amount of said Al₂O₃, B₂O₃ and R′O being 35% by weight or less.

In the present invention, it is possible to contain a rare earth element in an amount of 2 to 7% by weight calculates as an oxide thereof Ln₂O₃ (Ln: rare earth element), an Si element in an amount of 55 to 70% by weight calculated as an oxide thereof SiO₂, an alkali metal element in an amount of 9 to 17% by weight calculated as an oxide thereof R₂O (R: alkali metal element), an Al element in an amount of 8 to 17% by weight calculated as an oxide thereof A1₂O₃, a B element in an amount of 0 to 10% by weight calculated as an oxide thereof B₂O₃, and an alkali earth metal element in an amount of 0 to 10% by weight calculated as an oxide thereof R′O (R′: alkali earth metal element) based on the whole oxide-based glass.

In the present invention, it is possible to form, in the surface portion of the glass, a barrier layer which serves for inhibiting an alkali metal ion from diffusing to a surface on heating. This barrier layer can contain at least a silicon oxide.

Other objects, features and advantages of the invention will become apparent from the following description of the embodiments of the invention taken in conjunction with the accompanying drawings.

### BRIEF DESCRIPTION OF THE DRAWINGS

FIG. 1 is drawings illustrating comparatively the means for the glass strengthening treatment according to the present invention and the conventional means.

FIG. 2 is a diagrammatic illustration of the glass strengthening mechanism according to the present invention.

FIG. 3 is a graphic illustration of the relation between visible light transparency and strength, before and after the chemical strengthening treatment, according to the type of the rare earth element added.

FIG. 4 is a drawing illustrating the layout for the flexural strength test using a test piece.

FIG. 5 is a graphic illustration of the influence of the content of the rare earth element in the present invention.

FIG. 6 is a graphic illustration of the relation between heat treatment temperature and average flexural strength according to the presence or absence of a barrier layer.

FIG. 7 is a schematic plan illustrating the makeup of FED using the glass according to the present invention.

FIG. 8 is a perspective view showing the general structure of FED illustrated in FIG. 7.

FIG. 9 is a sectional view of FIG. 8.

### DESCRIPTION OF REFERENCE MARKS

HIG: high strength glass, CSL: chemically strengthened layer (compression strengthened layer), MC: microcrack, UIG: ultra-high strength glass, ODG: ordinary glass, OIG: ordinary strengthened glass, PNL1: back panel, PNL2: front panel, SUB1: back substrate, SUB2: front substrate, s (s1, s2, . . . sm): scanning signal wiring, d (d1, d2, d3, . . . ): picture signal wiring, ELS: electron source, ELC: connecting electrode, AD: anode, BM: black matrix, PH (PH(R), PH(G), PH(B)): phosphor layer, SDR: scanning signal line drive circuit, DDR: picture signal line drive circuit, SPC: spacer.

### DETAILED DESCRIPTION OF THE INVENTION

According to the present invention, by containing in the glass an oxide (Ln₂O₃) of Pr, Nd, Sm, Eu, Gd, Tb, Dy, Ho, Er, Tm, Yb or Lu, preferably an oxide (Ln₂O₃) of at least one element selected from the group consisting of Eu, Gd, Dy, Tm, Yb and Lu, more preferably an oxide of Gd, it is possible to realize salient enhancement of strength of glass by formation of a compression stress layer on the glass surface by a chemical treatment (alkali ion exchange).

SiO₂ is a main component for forming glass, and an alkali metal oxide (R₂O) is a component essential for the chemical strengthening (alkali ion exchange). By containing an oxide of Eu, Gd, Dy, Tm, Yb or Lu, the visible light transmittance of glass is elevated to provide a seemingly transparent glass which is useful as a structural member of transparent glass articles. By containing an oxide of Gd, it becomes possible, quite remarkably, to satisfy both requirements for enhancement of strength and visible light transparency.

Further incorporation of at least one element selected from the group consisting of Al elements, B elements and alkali earth metal elements in the oxide-based glass produces the following effects: Al element (Al₂O₃) is effective for preventing devitrification and improving chemical stability and strength, B element (B₂O₃) is useful for lowering glass making temperature and improving vitrification stability, and alkali earth metal oxide (R′O) contributes to the improvement of Young's modulus.

In case a rare earth element is contained in an amount of 1 to 10% by weight, preferably 2 to 7% by weight calculated as an oxide thereof Ln₂O₃ (Ln: rare earth element) based on the whole oxide-based glass, if the amount of Ln₂O₃ contained in the oxide-based glass is less than 1% by weight, its effect of enhancing glass strength is unsatisfactorily small, but if its amount exceeds 10% by weight, it tends to cause devitrification (crystallization) of glass. Therefore, the amount of this element contained in the glass should be in the range of 1 to 10% by weight, preferably 2 to 7% by weight.

In the chemical strengthening treatment in which ion exchange of alkali metal ions into ones with a larger ionic radius is conducted, viz. from Li ions into Na ions, and Na ions into K ions, in the surface portion alone in forming a compression stress layer, a remarkable strength enhancing effect can be obtained by setting the thickness of said compression stress layer at 20 μm or greater.

If the amount of Ln₂O₃ is less than 1% by weight based on the whole amount of the oxide-based glass, its effect of enhancing glass strength is small, while if its amount exceeds 10% by weight, the treated glass tends to devitrify (crystallize). If the content of SiO₂ is less than 50% by weight, the glass tends to devitrify, and if its amount exceeds 80% by weight, the melting temperature of the composition elevates to discommode glass making operations. If the amount of R₂O is less than 5% by weight, the melting temperature of the composition elevates to make the chemical strengthening treatment hard to carry out, and if its amount exceeds 20% by weight, chemical stability of the glass lowers excessively. Further, if the total amount of Ln₂O₃, SiO₂ and R₂O is less than 65% by weight, it is difficult to attain the desired enhancement of strength, prevention of devitrification and improvement of chemical stability. Therefore, the amounts of these oxides to be contained in the glass are preferably in the range defined in the Claims.

Use of Al₂O₃ in excess of 20% by weight based on the whole oxide-based glass results in an elevated melting temperature of the composition, making it hard to produce the desired glass. Use of B₂O₃ in excess of 20% by weight tends to cause phase separation and also adversely affects chemical stability of the glass. Use of R′O in excess of 20% by weight makes the glass fragile. Further, if the total amount of Al₂O₃, B₂O₃ and R′O exceeds 35% by weight, it becomes difficult to achieve all of the desired enhancement of strength, prevention of devitrification and improvement of chemical stability. Therefore, the amounts of these oxides contained in the base glass are preferably in the ranges defined in the Claims.

By containing a rare earth element in an amount of 2 to 7% by weight calculated as an oxide thereof Ln₂O₃ (Ln: rare earth element), an Si element in an amount of 55 to 70% by weight calculated as an oxide thereof SiO₂, an alkali metal element in an amount of 9 to 17% by weight calculated as an oxide thereof R₂O (R: alkali metal element), an Al element in an amount of 8 to 17% by weight calculated as an oxide thereof Al₂O₃, a B element in an amount of 0 to 10% by weight calculated as an oxide thereof B₂O₃, and an alkali earth metal element in an amount of 0 to 10% by weight calculated as an oxide thereof R′O (R′: alkali earth metal element), all based on the whole amount of the oxide-based glass, glass making is made easier and also improvements are made on strength, prevention of devitrification and chemical stability.

In the chemical strengthening treatment, the alkali ions are diffused to the surface on heating to lower glass strength. It is possible to prevent lowering of strength on heating by forming on the surface a coating (barrier layer) which is capable of suppressing surface diffusion of the alkali ions. Without such a barrier layer, the alkali metal ions are diffused to the glass surface on heating, and when other material is formed on the glass surface, their close adhesion is hard to obtain. A barrier is essential particularly in case heating of 350° C. or higher is required. This is especially effective for the structural members of electronic devices for displays (such as FPD) and glass structural members such as substrates of magnetic discs for which heat treatment is needed in their production process. Incorporation of silicon oxide same as the main component of glass in the barrier layer helps to provide good adhesion.

The scope of use of the present invention is not limited to the structural components of the display devices and the glass structural members of electronic devices such as substrates of magnetic discs; the invention can be also applied widely to the other objectives such as structural materials and window glass (including 2-layer glass and laminated glass) of buildings, substrates for solar batteries, structural members and window glass of vehicles, aircraft, spacecraft, etc., for which high strength and reduction of size and weight are essential requirements.

### EXAMPLES

The best mode for carrying out the present invention is described below.

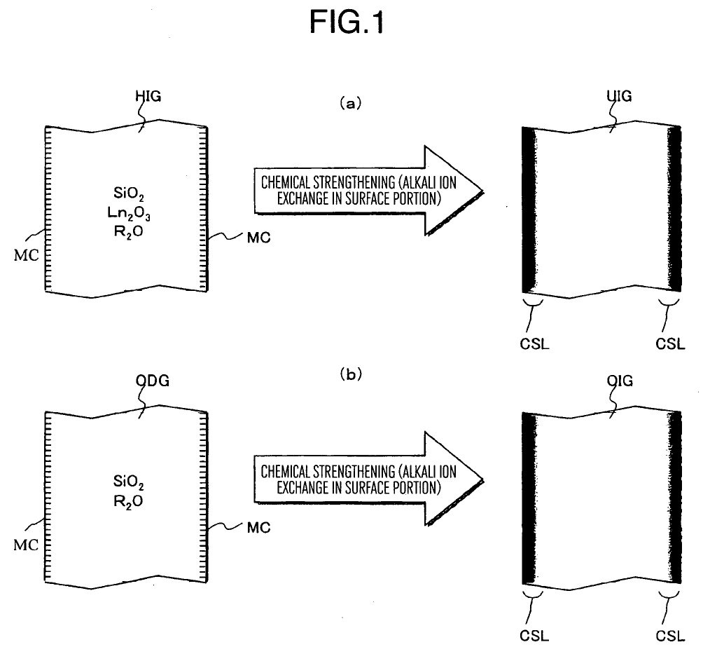

FIG. 1 is the diagrammatic drawings illustrating comparatively the means for glass strengthening treatment according to the present invention and the conventional means, in which FIG. 1(a) shows the strengthening means of the present invention and FIG. 1(b) shown the conventional means. Glass is shown by a partial section, and in the drawings, both right and left sides of each section are the surfaces. Usually the main component of glass is silicon oxide (SiO₂), and the alkali oxides of lithium (Li), sodium (Na) and such are mixed with silicon oxide to form “oxide-based glass.” In the present invention, as shown in FIG. 1(a), a rare earth oxide is added in the glass composed of silicon oxide and an alkali oxide to make a high-strength glass HIG which has been strengthened in its whole body, and this glass is further subjected to a chemical strengthening treatment to form a chemically strengthened layer (compression strengthened layer) CSL on the glass surface. This chemically strengthened layer CSL functions to prevent breaking of glass caused by the microcracks MC existing in the glass surface. According to the present invention, there is provided an ultra-high strength glass, or so-called “unbreakable glass” UIG, whose strength is 6 to 12 or more times that of ordinary glass.

On the other hand, according to the conventional strengthening means shown in FIG. 1(b), silicon oxide and a small quantity of an alkali oxide are mixed, with no rare earth oxide added, to make an oxide-based ordinary glass ODG, and this glass is subjected to the same chemical strengthening treatment as in the case of FIG. 1(a) to obtain ordinary strengthened glass OIG whose strength is about 2 to 3 times that of ordinary glass.

The treatment for forming the chemically strengthened layer CSL on the glass surface comprises dipping the high-strength glass HIG in a heated and melted nitrate to replace the lithium (Li) ions in the surface portion of said glass with the sodium (Na) ions and the sodium ions in the surface portion with the potassium (K) ions to obtain a compression strengthened layer CSL. Thickness of this compression strengthened layer CSL is 20 to 200 μm.

The rare earth oxide added in the glass in the present invention is an oxide (Ln₂O₃) of Pr, Nd, Sm, Eu, Gd, Tb, Dy, Ho, Er, Tm, Yb or Lu, preferably an oxide (Ln₂O₃) of at least one element selected from Eu, Gd, Dy, Tm, Yb and Lu, more preferably an oxide of Gd. By incorporating such a rare earth oxide in the glass, high strengthening of the whole glass can be realized, and further by forming a compression stress layer on both surfaces by chemical strengthening treatment (alkali ion exchange), it is possible to obtain a glass with extremely high strength.

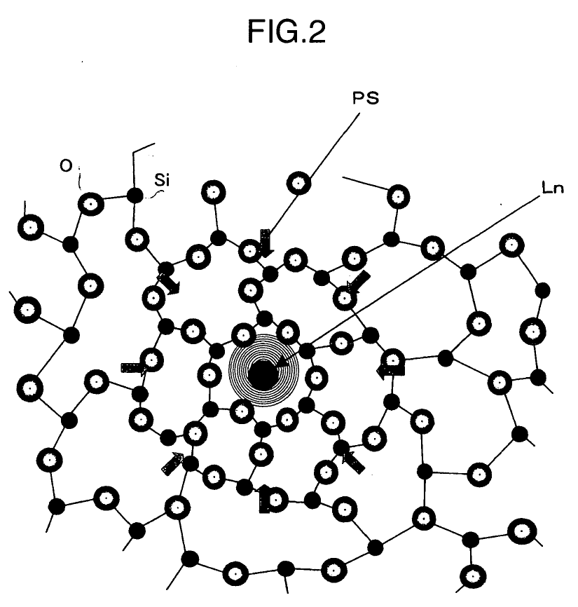

FIG. 2 is a diagrammatic illustration of the glass strengthening mechanism according to the present invention. The main component of the glass is SiO₂, and the glass has an oxygen skeletal structure shown in FIG. 2. It is considered that when a rare earth oxide Ln₂O₃ is added in this structure, the glass is strengthened in its whole body as the oxygen atoms O in the oxygen skeletal structure are attracted by the electric field of the added rare earth element Ln as shown by an arrow mark PS.

An alkali metal oxide (R₂O) is a component necessary for chemical strengthening treatment (alkali ion exchange). By conducting the said chemical strengthening treatment on the high-strength glass HIG which has been strengthened in its whole body by the addition of a rare earth oxide Ln₂O₃, a chemically strengthened layer (compression strengthened layer) CSL is formed as shown in FIG. 1(a), producing an ultra-high strength glass UIG which is proof against shattering caused by the microcracks.

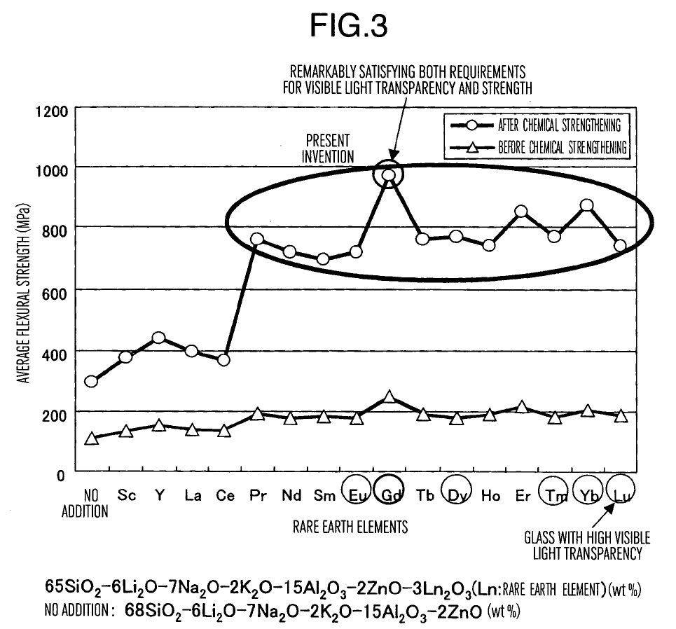

FIG. 3 is a graphic illustration of the relation between visible light transparency and strength before and after the chemical strengthening treatment according to the type of the rare earth element added. In the graph of FIG. 3, the rear earth elements are arranged in the order of elemental number on the horizontal axis, and average flexural strength (MPa) is plotted as ordinate. The composition and materials of the glass to which the rare oxides have been added in the flexural strength test, the amount of glass melted, the melting conditions, the annealing conditions and the flexural strength test conditions are as described below. In the graph, average flexural strength of the high-strength glass HIG before the chemical strengthening treatment is shown by the line connecting the plots of Δ, and average flexural strength of the ultra-high strength glass UIG after the chemical strengthening treatment is shown by the line connecting the plots of ◯.

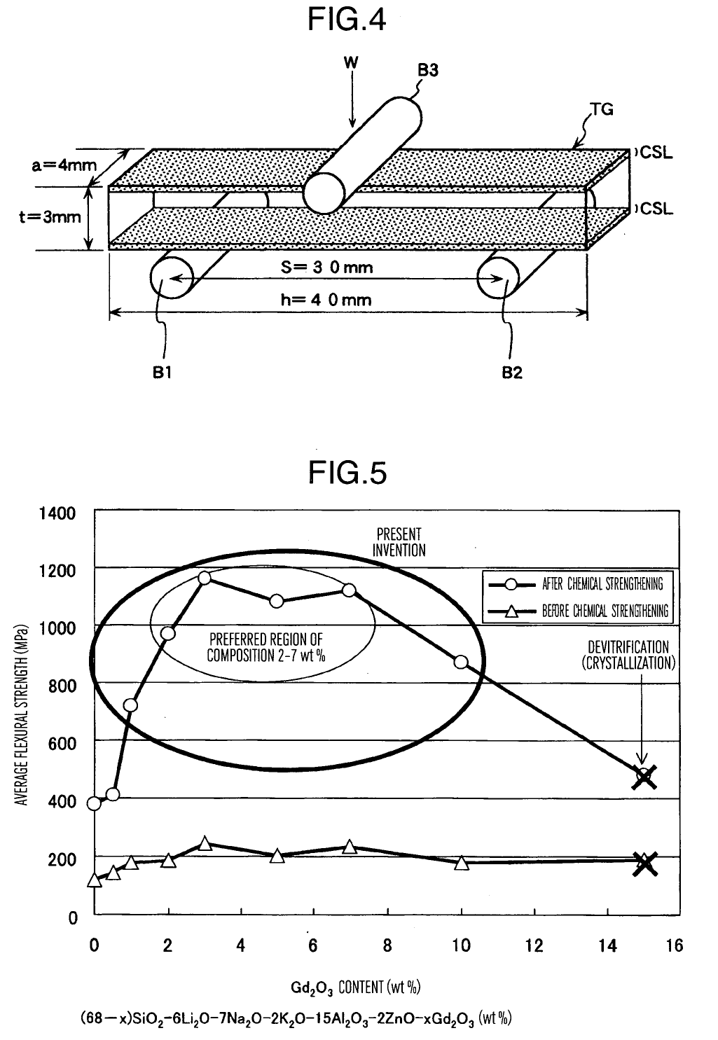

The above-mentioned average flexural strength test of the glass according to the present invention is explained here. In this average flexural strength test, the test pieces-were made from the glass blocks described below and the method explained with reference to FIG. 4 was used.

(1) Making of Glass Blocks

Composition: 65 wt % SiO₂, 6 wt % Li₂O, 7 wt % Na₂O, 2 wt % K₂O, 15 wt % Al₂O₃, 2 wt % ZnO, and 3 wt % Ln₂O₃ (Ln: rare earth element).

Materials used: SiO₂, LiCO₃, NaCO₃, KNO₃, Al₂O₃, ZnO and Ln₂O₃ (Ce alone was used in the form of CeO₃). (0.2 wt % of Sb₂O₃ was added as cleaner)

Amount of the materials melted: about 300 g.

Melting conditions: The materials were melted at 1,500-1,600° C. for 1.5 hour (0.5 hour in this period being used for stirring and glass homogenization), and the melt was cast into a mold to make a glass block, overheated at 550° C. for one hour, then gradually cooled at a cooling rate of 1° C./min and straightened.

The composition of the glass to which no rare earth oxide was added (indicated by “No addition” in the drawing) was 68 wt % SiO₂, 6 wt % Li₂O, 7 wt % Na₂O, 2 wt % K₂O, 15 wt % Al₂O₃ and 2 wt % ZnO.

As indicated by an oval in FIG. 3, Pr and the other rare earth elements with a greater elemental number than Pr produce a high strength enhancing effect. The glass containing an oxide of an encircled rare earth element, viz. Eu, Gd, Dy, Tm, Yb or Lu on the horizontal axis has high visible light transmittance and is seemingly transparent, so that this glass is useful as a transparent glass structural member. Particularly, by containing an oxide of Gd, it is possible to satisfy both requirements for enhancement of strength and visible light transparency of the glass.

Further, by incorporating at least one element selected from the group consisting of Al element, B element and alkali earth metal elements in the oxide-based glass, the following effects can be obtained. That is, Al element (Al₂O₃) is effective for preventing devitrification and improving chemical stability, and B element (B₂O₃) is helpful for lowering glass making temperature and improving vitrification stability, while the alkaline earth metal oxides (R′O) contribute to the improvement of Young's modulus.

In case a rare earth element is contained in an amount of 1 to 10% by weight, preferably 2 to 7% by weight calculated as an oxide thereof Ln₂O₃ (LN: rare earth element) based on the whole oxide-based glass, if the amount of Ln₂O₃ contained in the oxide-based glass is less than 1% by weight, its effect of enhancing glass strength is unsatisfactorily small, but if its amount exceeds 10% by weight, it tends to cause devitrification (crystallization) of glass. Therefore, the amount of this element contained in the glass should be in the range of 1 to 10% by weight, preferably 2 to 7% by weight.

(2) Preparation of Test Pieces

The test pieces measuring 4 mm in thickness (t), 4 mm in width (a) and 40 mm in length (h) were made from the glass blocks made in (1) according to JIS R1601.

(3) Conditions for Chemical Strengthening Treatment (Alkali Ion Exchange)

A 420° C. molten salt (NaNO₃: KNO₃=1:1 (by mole)) was used. The compression stress layer thickness: 40-60 μm (determined from observation of a glass section by a polarization microscope).

(4) Flexural Strength Test (3-Point Bending Test) Conditions

Three-point bending strength σ (MPa) was determined from the following equation:
σ=(3s·w/2a·t²) (1)

wherein s: span of the lower portion; w: breaking load;

a: width of the test piece; t: thickness of the test piece.

FIG. 4 illustrates the layout of the flexural strength test using a test piece. In this flexural strength test, as shown in FIG. 4, there are used two lower columns B1, B2 arranged parallel to and spaced apart from each other by a span s, and an upper column B3 disposed at a higher level than and parallel to the lower columns B1, B2 and positioned halfway between these lower columns. Here, the span s between the lower columns B1, B2 is set at 30 mm, and the test piece TG is placed above the two lower columns B1, B2 with the chemically strengthened layers CSL facing both upwards and downwards. The upper column B3 is positioned at a halfway point on the upper side of the test piece TG, and a load is applied in the direction of arrow W. The load at break of the test piece TG is expressed by w, and the flexural strength is determined from the equation (1).

FIG. 5 is a graph illustrating the influence of the content of the rear earth elements in the present invention. In the graph, the content (wt %) of Gd₂O₃ is plotted as abscissa and the average flexural strength (MPa) as ordinate. In the graph, the average flexural strength of the high-strength glass HIG before the chemical strengthening treatment is indicated by the line connecting the plots of Δ, and the average flexural strength of the ultra-high strength glass UIG after the chemical strengthening treatment is indicated by the line connecting the plots of ◯. In this test, Gd₂O₃ was used as the rare earth element, and a GD element was contained in the glass. The composition of this Gd element-containing glass HIG was (68-x) wt % SiO₂, 6 wt % Li₂O, 7 wt % Na₂O, 2 wt % K₂O , 15 wt % Al₂O₃, 2 wt % ZnO and x wt % Gd₂O₃.

Measurements in FIG. 5 were made by using the same test piece under the same flexural strength test conditions as described above. The chemical strengthening treatment was conducted by using a 430° C. molten salt (NaNO₃: KNO₃=1:1 (by mole)), with the thickness of the compression stress layer being made 50-70 μm (by observing a glass section by a polarization microscope).

As shown in FIG. 5, in view of the fact the glass with an average flexural strength of approximately 700 MPa or higher is acceptable for practical use, the allowable content of Gd₂O₃ is in the region enclosed by a thick-lined oval, preferably in the region enclosed by a fine-lined oval. It should be noted that when the content of Gd₂O₃ exceeds approximately 15% by weight, crystallization takes place to cause devitrification.

Here, the influence on flexural strength of other components in the glass composition is explained. As the glass component materials, Gd₂O₃, Er₂O₃, Yb₂O₃, SiO₂, Li₂CO₃, Na₂CO₃, KNO₃, Al₂O₃, MgCO₃, CaCO₃, SrCO₃ and ZnO were used, and 0.2% by weight of Sb₂O₃ was added as a cleaner.

Using the above materials, the glass blocks were made under the same conditions as described above, and the test pieces of the same size were prepared therefrom. Using these test pieces, the flexural strength test was conducted with the same layout and under the same conditions as in the case of FIG. 4. The chemical strengthening treatment was carried out by using a 400° C. molten salt (NaNO₃: KNO₃=1:1 (by mole), with the compression stress layer (chemically strengthened layer CSL) thickness being set at 20-40 μm. The compositions and the average 3-point bending strength after the chemical strengthening treatment for each composition are shown in Table 1.

TABLE 1
Compositions and average 3-point bending strength after chemical
strengthening treatment

| | | | | | | | | | | | | | | Flexural |
|---|---|---|---|---|---|---|---|---|---|---|---|---|---|---|
| | Gd₂O₃ | Er₂O₃ | Yb₂O₃ | SiO₂ | Li₂O | Na₂O | K₂O | Al₂O₃ | B₂O₃ | MgO | CaO | SrO | ZnO | strength (MPa) |
| Example a | 3 | — | — | 80 | 6 | 11 | — | — | — | — | — | — | — | 646 |
| Example b | 3 | — | 2 | 75 | 6 | 12 | 2 | — | — | — | — | — | — | 678 |
| Example c | — | — | 3 | 70 | 9 | 7 | 1 | 10 | — | — | — | — | — | 786 |
| Example d | 3 | — | — | 65 | 9 | 5 | 2 | 14 | — | — | — | — | 2 | 876 |
| Example e | 2 | 2 | 1 | 60 | 7 | 7 | 1 | 17 | 3 | — | — | — | — | 838 |
| Example f | 3 | 1 | — | 55 | 6 | 5 | — | 8 | 20 | — | — | — | 2 | 757 |
| Example g | — | 3 | — | 50 | 5 | 10 | 2 | 20 | 10 | — | — | — | — | 695 |
| Example h | — | — | 5 | 60 | 4 | 7 | — | 8 | 6 | 6 | 4 | — | — | 787 |
| Example i | 3 | — | — | 60 | 2 | 3 | — | 5 | 7 | 4 | 9 | 7 | — | 739 |
| Example j | 3 | — | — | 65 | 5 | 6 | 1 | 16 | — | 3 | — | — | 1 | 829 |
| Example k | 5 | — | — | 56 | 4 | 5 | — | 3 | 15 | 4 | 2 | 6 | — | 690 |
| Example j | 3 | — | — | 55 | 2 | 4 | 1 | 12 | 10 | 5 | — | 5 | 3 | 753 |
| Example m | 3 | 2 | — | 65 | 3 | 4 | 2 | 17 | — | 2 | — | — | 2 | 810 |
| Example n | 3 | — | 2 | 63 | 9 | 4 | 1 | 16 | — | — | — | — | 2 | 846 |
| Example o | 4 | — | — | 56 | 2 | 3 | — | — | 15 | 7 | 6 | 7 | — | 687 |
| Example p | 3 | 2 | 2 | 69 | 7 | 10 | — | 3 | — | 2 | 2 | — | — | 738 |
| Example q | — | 3 | 1 | 60 | 8 | 6 | 3 | 15 | 2 | — | — | — | 2 | 826 |
| Comp. | — | — | — | 70 | — | 15 | — | 2 | — | — | 13 | — | — | 268 |
| Example A | | | | | | | | | | | | | | |
| Comp. | — | — | — | 71 | 2 | 13 | 1 | 1 | — | 3 | 9 | — | — | 281 |
| Example B | | | | | | | | | | | | | | |
| Comp. | — | — | — | 58 | — | — | — | 3 | 15 | 7 | 8 | 7 | 2 | 162 |
| Example C | | | | | | | | | | | | | | |
| Comp. | — | — | — | 49 | 1 | 1 | 1 | 3 | 22 | 8 | 10 | 5 | — | 183 |
| Example D | | | | | | | | | | | | | | |
| Comp. | — | — | — | 65 | 6 | 8 | 1 | 16 | — | 3 | — | — | 1 | 325 |
| Example E | | | | | | | | | | | | | | |
| Comp. | — | — | — | 65 | 9 | 5 | 2 | 17 | — | — | — | — | 2 | 315 |
| Example F | | | | | | | | | | | | | | |

In Table 1, the various compositions were represented by Example a through Example q, and the glass samples containing no rare earth element were represented by Comparative Example A through Comparative Example F for comparison. As seen from the numerical values given in the column of Flexural strength in Table 1, the glass preparations according to the present invention are far higher in flexural strength than those containing no rare earth element.

Next, heat resistance of the glass according to the present invention is explained. In the glass which has undergone the chemical strengthening treatment, the alkali ions are diffused to the surface on heating to reduce strength. Such reduction of strength on heating can be prevented by forming on the glass surface a coating (barrier layer) which is capable of inhibiting surface diffusion of the alkali ions. This barrier layer forming treatment can be preferably applied to the glass structural members for the devices which require a heat treating process in their production, such as flat panel displays (FPD).

The composition of the glass provided with a barrier layer was 65 wt % SiO₂, 6 wt % Li₂O, 7 wt % Na₂O, 2 wt % K₂O, 15 wt % Al₂O₃, 2 wt % ZnO and 3 wt % Gd₂O₃, and the materials used for glass making were SiO₂, LiCO₃, NaCO₃, KNO₃, Al₂O₃, ZnO and Ln₂O₃ (Ce alone was used in the form of CeO₂). (Sb₂O₃ was added in an amount of 0.2% by weight as cleaner). The amount of the materials melted was about 3 kg, and the melting conditions were 1,500-1,600° C. and 3 hours (0.5 hour in this period being applied to stirring and glass homogenization). The melt was cast into a mold to make a glass block, and it was overheated at 550° C. for one hour, then gradually cooled at a cooling rate of 1° C./min and straightened.

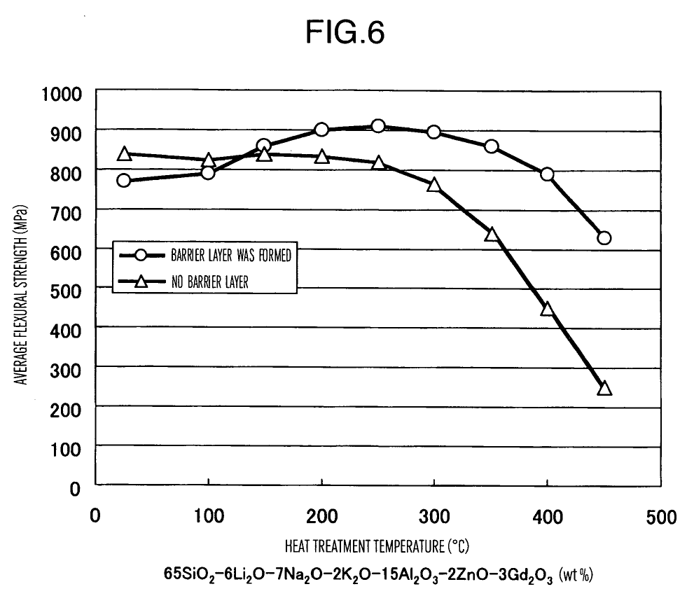

FIG. 6 is a graph showing the relation between heat treatment temperature and average flexural strength when a barrier layer was provided and when not. The size of the test piece was the same as that shown in FIG. 4, and the conditions of the chemical strengthening treatment (alkali ion exchange) were a 400° C. molten salt (NaNO₃: KNO₃=1:12 (by mole)) and the compression stress layer (chemically strengthened layer CSL) thickness of 20-40 μm. Thickness of this CSL layer was determined by observing a glass section by a polarization microscope.

In forming the barrier layer, the surface of the test piece of was pickled to remove some of the alkali metal ions on the surface and then a silicon oxide-based coating was formed by the sol-gel method. The thus prepared test pieces were heated at 100° C., 150° C., 200° C., 250° C., 300° C., 350° C., 400° C. and 450° C., each for 10 minutes, and flexural strength was determined by the layout and conditions explained with FIG. 4. The results are shown in FIG. 6.

As shown in FIG. 6, the test pieces with no barrier layer begin to lower in flexural strength at around 250° C., but the test pieces provided with the barrier layer maintain flexural strength of about 800 MPa even at around 400° C.

Now, resistance to impact fractures of the glass according to the present invention is described. The test of resistance to impact fractures was conducted by holding a 150 mm×150 mm×2.5 mm thick test piece horizontally and gravitationally dropping a 450 g steel ball to the test piece from above thereof. In the Example of this invention, there was used a rare earth element-containing glass of the present invention which has been subjected to the chemical strengthening treatment. The chemical strengthening treatment was conducted with a 450° C. molten salt (NaNO₃: KNO₃=1:1 (by mole)), with the thickness of the compression stress layer (chemically strengthened layer CSL) being set at 60-80 μm. Thickness of this chemically strengthened layer CSL was determined by observing a glass section by a polarization microscope. In the Comparative Examples, there were used the samples of ordinary glass containing no rare earth element, with or without the chemically strengthened layer provided.

The composition of the rare earth element-containing glass according to the present invention was 65 wt % SiO₂, 6 wt % Li₂O, 7 wt % Na₂O, 2 wt % K₂O, 15 wt % Al₂O₃, 2 wt % ZnO and 3 wt % Gd₂O₃. The composition of the glass samples of the Comparative Examples was 71 wt % SiO₂, 2 wt % Li₂O, 13 wt % Na₂O, 1 wt % K₂O, 1 wt % Al₂O₃, 3 wt % MgO and 9 wt % CaO₃. Used as the materials of the glass were SiO₂, Li₂CO₃, NaCO₃, KNO₃, Al₂O₃, ZnO, Gd₂O₃, MgO₃ and CaCO₃ (with 0.2% by weight of Sb₂O₃ being added as cleaner). The amount of the materials melted was about 10 kg, and the melting conditions were 1,500° C. and 5 hours (with 3 hours of this period being used for stirring and glass homogenization). The melt was cast into a mold to make a glass block, which was heated at 550° C. for 2 hours, then gradually cooled at a cooling rate of 1° C./min and straightened.

The impact fracture resistance test is a test according to JIS C8917 in which, with the layout described above, a steel ball with a mass of 450 g was dropped to a piece of glass from the heights of 25 cm, 50 cm, 75 cm, 100 cm, 125 cm and 150 cm. The results are shown in Table 2. 3 test pieces were used in the drop test for each height. In Table 2, 0 indicates no test piece fractured, Δ indicates part of the test pieces fractured, and X indicates all of the test pieces fractured. As seen from Table 2, the test pieces of rare earth element-containing glass subjected to the chemical strengthening treatment according to the present invention (Example) suffered no fracture by drop of the steel ball from the heights of up to 100 cm, with only one test piece being fractured by drop of the steel ball from the height of 125 cm. This indicates that the rare earth element-containing glass according to the present invention has far higher strength than the glass samples of the Comparative Examples.

TABLE 2

| | 25 cm | 50 cm | 75 cm | 100 cm | 125 cm | 150 cm |
|---|---|---|---|---|---|---|
| Example | ◯ | ◯ | ◯ | ◯ | Δ | X |
| (with chemical | | | | | one test | |
| strengthening | | | | | piece | |
| treatment) | | | | | was | |
| | | | | | broken | |
| Comparative | ◯ | ◯ | Δ | X | X | X |
| Example | | | two test | | | |
| (with chemical | | | pieces | | | |
| strengthening | | | were | | | |
| treatment) | | | broken | | | |
| Comparative | ◯ | X | X | X | X | X |
| Example | | | | | | |
| (no chemical | | | | | | |
| strengthening | | | | | | |
| treatment) | | | | | | |

As viewed above, the glass according to the present invention has required strength even if small in thickness, and when it has a large thickness, its safety and reliability are appreciably increased. Thus, the scope of use of the present invention is not limited to the electronic devices such as panel glass for FPD and solar batteries; the invention can be applied as well to the fields of buildings, vehicles, aircraft, spacecraft, etc.

Here, the results of the tests on impact fracture resistance of the laminated glass (glass laminates) according to the present invention are explained. The compositions of the test pieces and the materials thereof are the same as used in the impact fracture tests on the single-layer glass described above, but the amount of the materials melted was about 17 kg and the melting conditions were 1,500° C. and 6 hours (in which 3.5 hours was used for stirring and glass homogenization). The melt was cast into a mold to make a glass block, and it was heated at 550° C. for 3 hours, then gradually cooled a cooling rate of 1° C./min and straightened.

The following 3 different test pieces were cut out from the said glass block and subjected to optical polishing:
Test piece for single layer glass: 150 mm×150 mm×3.0 mm
Test piece for 2-layer glass: 150 mm×150 mm×1.5 mm
Test piece for 3-layer glass: 150 m×150 mm×1.0 mm

The chemical strengthening treatment comprised dipping in a 430° C. molten salt (NaNO₃: KNO₃=1:1 (by mole)), with the thickness of the compression stress layer (chemically strengthened layer) CSL being set at 40-60 μm.

After forming a chemically strengthened layer, a synthetic resin EVA (ethylene-vinyl acetate copolymer) was sandwiched between the test pieces for 2-layer glass and pressed together to make 2-layer laminated glass, and EVA was sandwiched between the respective test pieces for 3-layer glass and pressed together to make 3-layer laminated glass. The attached layer thickness was about 0.3 mm. The test piece for single-layer glass is intended for comparison with laminated glass, and it represents the overall thickness of glass exclusive of the glass thickness of 2-layer laminated glass (1.5 mm+1.5 mm=3.0 mm), glass thickness of 3-layer laminated glass (1.0 mm+1.0 mm+1.0 mm=3.0 mm) and the resin.

Table 3 shows the results of the impact facture test by drop of a steel ball on the 2-layer and 3-layer glass laminates, along with the test results on the test piece for single-layer glass with the same thickness. The mass of the steel ball used was 1.2 kg. This test was also a test according to JIS C8917 in which, with the layout described above, a steel ball of 1.2 kg in mass was dropped onto the test piece from the heights of 25 cm, 50 cm, 75 cm, 100 cm, 125 cm and 150 cm. Three test pieces were used in the drop test for each height. In Table 3, ◯ indicates no test piece fractured, Δ indicates part of the test pieces fractured, and x indicates all of the test pieces fractured.

As seen from the results shown in Table 3, the laminated glass formed by using the rare earth element-containing glass subjected to the chemical strengthening treatment according to the present invention (Example) is appreciably strengthened in comparison with the single-layer glass of the same thickness, and even if such laminated glass is fractured, there takes place no scattering of its fragments.

TABLE 3

| | 25 | 50 | | | | |
|---|---|---|---|---|---|---|
| | cm | cm | 75 cm | 100 cm | 125 cm | 150 cm |
| Example | ◯ | ◯ | X | X | X | X |
| (single | | | Scattering | Scattering | Scattering | Scattering |
| layer) | | | and | and | and | and |
| | | | falling | falling | falling | falling |
| | | | occurred | occurred | occurred | occurred |
| Example | ◯ | ◯ | ◯ | Δ | X | X |
| (2-layer | | | | (two test | No | No |
| laminate) | | | | pieces | scattering | scattering |
| | | | | were | and | and |
| | | | | broken) | falling | falling |
| | | | | No | | |
| | | | | scattering | | |
| | | | | and | | |
| | | | | falling | | |
| Example | ◯ | ◯ | ◯ | ◯ | ◯ | X |
| (3-layer | | | | | | No |
| laminate) | | | | | | scattering |
| | | | | | | and |
| | | | | | | falling |

The present invention described above may be summarized as follows.

In carrying out the chemical strengthening treatment for forming a compression stress layer by conducting alkali ion exchange for forming ions with a larger ionic radius, viz. from Li ions into Na ions, and from Na ions into K ions, in the surface portion alone, a remarkable strength enhancing effect can be obtained by making the thickness of the said compression stress layer 20 μm or greater.

Regarding the amounts of the materials in the whole oxide-based glass, if the content of Ln₂O₃ is less than 1% by weight, its strength enhancing effect is small, and if its content exceeds 10% by weight, the produced glass tends to devitrify (crystallize). If the content of SiO₂ is less than 50% by weight, the product glass tends to devitrify, and if its content exceeds 80% by weight, the melting temperature elevates, making the glass marking operation hard to carry out. When the content of R₂O is less than 5% by weight, the melting temperature elevates and the chemical strengthening treatment becomes difficult to conduct, and when its content exceeds 20% by weight, chemical stability of the product glass lowers excessively. Further, if the total amount of Ln₂O₃, SiO₂ and R₂O is less than 65% by weight, it is difficult to realize the intended enhancement of strength, prevention of devitrification and improvement of chemical stability. Therefore, the contents of these materials in the glass preferably fall in the range defined in the Claims.

If the content of Al₂O₃ exceeds 20% by weight based on the whole oxide-based glass, the melting temperature elevates to make the glass making operation hard to carry out. If the content of B₂O₃ exceeds 20% by weight, phase separation tends to take place in glass and also its chemical stability lowers. When the content of R′O exceeds 20% by weight, the produced glass becomes fragile. Further, if the total amount of Al₂O₃, B₂O₃ and R′O exceeds 35% by weight, it is difficult to realize the intended enhancement of strength, prevention of devitrification and improvement of chemical stability. Therefore, the contents of these materials preferably fall in the range defined in the Claims.

By containing a rare earth element in an amount of 2 to 7% by weight calculated as an oxide thereof Ln₂O₃ (Ln: rare earth element), a Si element in an amount of 55 to 70% by weight calculated as an oxide thereof SiO₂, an alkali metal element in an amount of 9 to 17% by weight calculated as an oxide thereof R₂O (R: alkaline metal element), an Al element in an amount of 8 to 17% by weight calculated as an oxide thereof Al₂O₃, a B element in an amount of 0 to 10% by weight calculated as an oxide thereof B₂O₃, and an alkali earth metal element in an amount of 0 to 10% by weight calculated as an oxide thereof R′O (R′: alkali earth metal element), all based on the whole amount of the oxide-based glass, glass making is made easier and also strength, anti-devitrification tendency and chemical stability are improved.

In the chemical strengthening treatment, the alkali ions are diffused to the surface on heating to lower glass strength. It is possible to prevent lowering of strength on heating by forming on the surface a coating (barrier layer) which is capable of suppressing surface diffusion of the alkali ions. Without such a barrier layer, the alkali metal ions are diffused to the glass surface on heating, and when other material is formed on the glass surface, their close adhesion is hard to obtain. A barrier is essential particularly in case heating of 350° C. or higher is required. This is especially effective for the structural members of electronic devices for displays (such as FPD) and glass structural members such as substrates of magnetic discs for which heat treatment is needed in their production process. Incorporation of silicon oxide same as the main component of glass in the barrier layer is helpful for providing good adhesion.

In the following, an example of flat panel display (FPD) which is one of the most promising fields of application of the glass of the present invention is explained.

As one of the self-emission type FPD having an electron source arranged as a matrix, there are known field emission displays (FED) and electron emission displays utilizing the cold cathodes capable of integration with low power. For these cold cathodes, there are used, for instance, spindt type electron source, surface conduction type electron source, carbon nanotube type electron source, metal-insulator-metal (MIM) laminate type, metal-insulator-semiconductor (MIS) laminate type, and metal-insulator-semiconductor-metal type thin-film electron sources.

Self-emission type FPD has a display panel comprising a back panel provided with electron sources such as mentioned above, a front panel provided with phosphor layers and an anode issuing an accelerating voltage for bombarding the electrons emitted from the electron sources, and a sealing frame for sealing the inside space between the two opposing panels in a prescribed evacuated state. The back panel has the said electron sources formed on a back substrate, and the front panel has the phosphor layers formed on a front substrate and an anode issuing an accelerating voltage for forming an electric field for bombarding the electrons emitted from the electron sources against the phosphor layers. A drive circuit is combined with this display panel. Usually, the back panel, front panel and sealing frame are made of glass. By using the said glass of the present invention for these parts, it is possible to realize an FPD which is small in size and weight and resistant to breakage.

Each electron source makes a pair with a corresponding phosphor layer to constitute a unit pixel. Usually, one pixel (color pixel) is composed of unit pixels of three colors, viz. red (R), green (G) and blue (B). In the case of color pixel, the unit pixel is also called sub-pixel.

The front and back panels are separated by a member called spacer to keep a prescribed space between them. This spacer is a plate-like member made of an insulating material such as glass or ceramic or a material having a certain degree of conductivity, and it is provided for each group of pixels at a position where it will not hinder the movement of the pixels. By using the glass of the present invention for this spacer, it is possible to realize a thin, light-weight and breakage-resistant FPD.

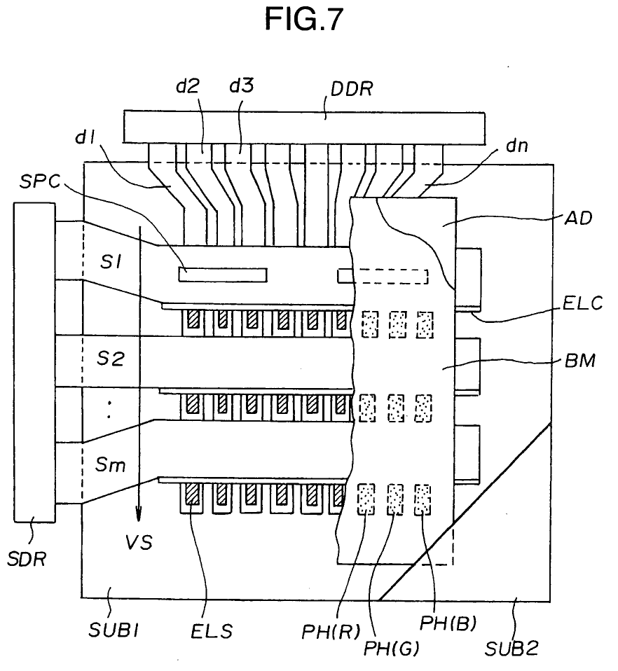

FIG. 7 is a diagrammatic plan showing the structure of an FED using the glass according to the present invention. The back substrate SUB1 of the back panel is made of the glass according to the present invention. Picture signal lines d (d1, d2, . . . dn) are formed on the inner surface of the substrate, and scanning signal lines s (s1, s2, s3, . . . dn) are formed thereon crossing the lines d. The picture signal lines d are driven by a picture signal drive circuit DDR, and the scanning signal lines s are driven by a scanning signal drive circuit SDR. In FIG. 7, spacers SPC are provided above the scanning signal line s1, and the electron sources ELS are provided on the downstream side of the spacers SPC in the vertical scanning direction VS. Power is supplied from the connecting electrodes ELC through the scanning signal lines s (s1, s2, s3, . . . sm). These spacers SPC are also made of the glass of the present invention.

The front substrate SUB2 of the front panel is made of the glass according to the present invention. An anode electrode AD is provided on the inner surface of the substrate, and phosphor layers PH (PH(R), PH(G), PH(B)) are formed on said anode electrode AD. With this arrangement, the phosphor layers PH (PH(R), PH(G), PH(B)) are comparted by a light shielding layer (black matrix) BM. The anode electrode AD is shown as a solid electrode, but it may be constituted as stripe electrodes arranged to cross the scanning signal lines s (s1, s2, s3, . . . sm) and divided for each row of pixels. The electrons emitted from the electron sources ELS are accelerated and bombarded against the phosphor layers PH (PH(R), PH(G), PH(B)) constituting the corresponding sub-pixels. Consequently, the said phosphor layers PH emit light with a prescribed color and it is mixed with the color of the light emitted from the phosphor of the other sub-pixels to constitute a color pixel of a prescribed color.

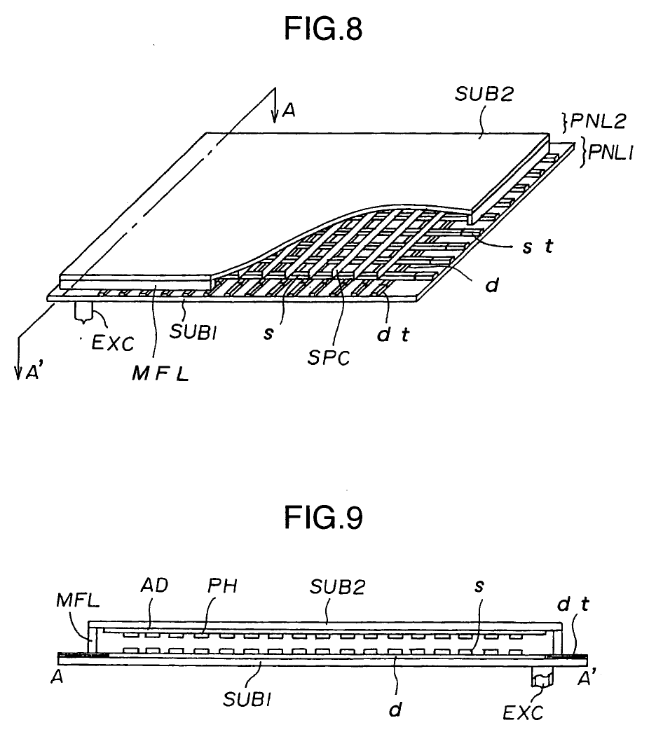

FIG. 8 is a perspective view showing the whole structure of the FED explained with reference to FIG. 7, and FIG. 9 is a sectional view thereof. FIG. 9 shows a glass section cut parallel to the spacers SPC which are not shown in the drawing. On the inner surface of the back substrate SUB1 of the back panel PNL1, there are provided picture signal lines d and electron sources disposed close to the crossings of the matrices of scanning signal lines S. Picture signal lines d are led out to the outside of the sealing frame MFL to form leader terminals dt. Similarly, scanning signal lines s are also lead out to the outside of the sealing frame MFL to form leader terminals st. On the other hand, an anode AD and phosphor layers PH are provided on the inner side of the front substrate SUB2 of the front panel PNL2. Anode AD comprises an aluminum layer.

The front panel PNL2 and the back panel PNL1 are opposed to each other, and in order to keep a prescribed space between them, the rib-like spacers SPC of approximately 80 μm in width and approximately 2.5 mm in height are provided above and in the extending direction of the scanning signal wiring and secured in position by using fritted glass or other means. A glass-made sealing frame MFL is provided at the peripheral edges of both panels and fixed in position by fritted glass (not shown) so that the internal space held by both panels will be isolated from the outside.

For fixing the spacers with fritted glass, they are heated at 400-450° C., and then the system is evacuated to about 1 μPa through an evacuating tube 303 and then sealed. In operation, a voltage of about 5-10 kV is applied to the anode AD on the front panel PNL2.

It should be further understood by those skilled in the art that although the foregoing description has been made on embodiments of the invention, the invention is not limited thereto and various changes and modifications may be made without departing from the spirit of the invention and the scope of the appended claims.

1. A glass member comprising:
an oxide-based glass containing at least one rare earth element selected from the group consisting of Pr, Nd, Sm, Eu, Gd, Tb, Dy, Ho, Er, Tm, Yb and Lu and also containing at least an Si element and an alkali metal element; and
a compression stress layer formed in a surface portion of the oxide-based glass.

2. The glass member according to claim 1 wherein said oxide-based glass further contains at least one element selected from the group consisting of Al element, B element and an alkali earth metal element.

3. The glass member according to claim 1 wherein said rare earth element is contained in an amount of 1 to 10% by weight calculated as an oxide thereof Ln₂O₃ (Ln: rare earth element), based on the whole oxide-based glass.

4. The glass member according to claim 3 wherein said rare earth element is contained in an amount of 2 to 7% by weight calculated as an oxide thereof Ln₂O₃ (Ln: rare earth element), based on the whole oxide-based glass.

5. The glass member according to claim 1 wherein said rare earth element is at least one element selected from the group consisting of Eu, Gd, Dy, Tm, Yb and Lu.

6. The glass member according to claim 5 wherein said rare earth element is at least Gd.

7. The glass member according to claim 1 wherein said compression stress layer is formed by a chemical strengthening treatment comprising an alkali ion exchange.

8. The glass member according to any one of claims 1 to 7 wherein said compression stress layer has a thickness of 20 μm or greater.

9. The glass member according to any one of claims 1 and 5 to 7 wherein a content of said rare earth element is 1 to 10% by weight calculated as an oxide thereof Ln₂O₃ (Ln: rare earth element), a content of said Si element is 50 to 80% by weight calculated an oxide thereof SiO₂, and a content of said alkali metal element is 5 to 20% by weight calculated as an oxide thereof R₂O (R: alkali metal element), all based on the whole oxide-based glass, with the total amount of said Ln₂O₃, SiO₂ and R₂O being 65% by weight or more.

10. The glass member according to claim 2 wherein a content of said Al element is 20% by weight or less calculated as an oxide thereof Al₂O₃, a content of said B element is 20% by weight or less calculated as an oxide thereof B₂O₃ and a content of said alkali earth metal element is 20% by weight or less calculated as an oxide thereof R′O (R: alkali earth metal element), all based on the whole oxide-based glass, with the total amount of said Al₂O₃, B₂O₃ and R′O being 35% by weight or less.

11. The glass member according to any one of claims 2 to 7 wherein a content of said rare earth element is 2 to 7% by weight calculated as an oxide thereof Ln₂O₃ (Ln: rare earth element), a content of said Si element is 55 to 70% by weight calculated as an oxide thereof SiO₂, a content of said alkali metal element is 9 to 17% by weight calculated as an oxide thereof R₂O (R: alkali metal element), a content of said Al element is 8 to 17% by weight calculated as an oxide thereof Al₂O₃, a content of said B element is 0 to 10% by weight calculated as an oxide thereof B₂O₃, and a content of said alkali earth metal element is 0 to 10% by weight calculated as an oxide thereof R′O (R′: alkali earth metal element), all based on the whole oxide-based glass.

12. The glass member according to any one of claims 1 to 7 wherein a barrier layer for preventing an alkali metal ion from diffusing to a surface on heating is formed in the surface portion of said glass.

13. The glass member according to claim 12 wherein said barrier layer contains at least a silicon oxide.
